(19) United States
(12) Patent Application Publication
(10) Pub. No.: US 2023/0419222 A1
(43) Pub. Date: Dec. 28, 2023

(54) METHOD TO OPTIMIZE CLEANING OF SOLAR PANELS THROUGH QUANTIFICATION OF LOSSES IN PHOTOVOLTAIC MODULES IN SOLAR POWER PLANTS

(71) Applicant: DT360 INC., Natick, MA (US)

(72) Inventors: Krishnaparacharan Srinivasaraghavan, Chennai (IN); Rajasekaran Panchatcharam, Chennai (IN); Ganapathy Subramanium Sundar Ramaswamy, Chennai (IN); Sivarama Krishnan Balasubramanian, Chennai (IN); Mirra Amritha, Chennai (IN)

(73) Assignee: DT360 INC., Natick, MA (US)

(21) Appl. No.: 18/216,993

(22) Filed: Jun. 30, 2023

Related U.S. Application Data
(63) Continuation-in-part of application No. 17/157,412, filed on Jan. 25, 2021.
Application No. 17/157,412 is a continuation-in-part of application No. 16/389,493, filed on Apr. 19, 2019, now Pat. No. 10,902,368.
Application No. 16/389,493 is a continuation-in-part of application No. 15/921,456, filed on Mar. 14, 2018, now abandoned.
Application No. 15/921,456 is a continuation of application No. 14/205,377, filed on Mar. 12, 2014, now abandoned.
(60) Provisional application No. 63/357,167, filed on Jun. 30, 2022.

(51) Int. Cl. G06Q 10/0635; G06Q 10/0637; G06Q 10/067

(52) U.S. Cl. CPC G06Q 10/0635; G06Q 10/0637; G06Q 10/067

(57) ABSTRACT

A method is designed and implemented to identify and quantify the different losses that are possible in a solar power plant. Data is acquired through RETINA's remote nodes from the SCADA systems which are connected to the electrical meters and sensors attached to inverters and combiner boxes in a solar power plant. The resulting data is cleansed, filtered, and archived into a data-warehouse to estimate the solar losses by devising and estimating against an “ideal” combiner box current trend. The quantified losses further form the input to a system which identifies an optimal cleaning schedule of the power plant with specifications about the labor and resources that are used.

This application is a non-provisional patent application claiming the benefit and priority of Provisional Patent Application No. 63/357,167 filed on Jun. 30, 2022, and is continuation-in-part of and claims the benefit and priority of U.S. patent application Ser. No. 17/157,412 filed on Jan. 25, 2021, which is a continuation-in-part of U.S. patent application Ser. No. 16/389,493 filed on Apr. 19, 2019, now U.S. Pat. No. 10,902,368 which is a continuation-in-part of U.S. patent application Ser. No. 15/921,456, filed on Mar. 14, 2018, which is a continuation of U.S. patent application Ser. No. 14/205,377 filed on Mar. 12, 2014. The entire contents of such applications are incorporated herein by reference.

### FIELD OF THE INVENTION

The present invention relates to a method to quantify the energy losses during production of electrical power from photovoltaic modules in solar power plants using RETINA (Real time integration Analytics Software) to identify the photovoltaic modules which are impacted by soiling caused due to accumulation of dust and other materials on top of these modules. The method further derives an optimized cleaning schedule and assesses the resources and labor that would be associated with a cleaning activity to reduce the loss caused by soiling of these photovoltaic modules.

### BACKGROUND OF THE INVENTION AND PRIOR ART

A solar power plant is an arrangement of several devices and equipment that can harness the radiation from the sun directly and convert it to electrical power. Such plants primarily comprise of three sections. The energy from the sun is captured through flat panels called photovoltaic modules. These modules are made of specialized materials such as Silicon, Cadmium and Tellurium. These modules generate electrical current proportional to the solar radiation that falls on its surface which is then transmitted to electrical devices called inverters. Inverters convert the electrical current from the photovoltaic modules into a form suitable for transmission over long distances. To maximize the radiation that falls on the photovoltaic modules, solar power plants are usually constructed in places with minimal objects or obstructions to avoid any shadows falling upon these modules which would reduce their generation capability. Certain installations are also provided with trackers that change the orientation of the panels at a determined frequency from the morning till the evening hours of operation. Over a brief period, the photovoltaic modules are subject to a phenomenon called soiling, caused due to deposition of sand and dirt carried by wind, droppings from birds flying over the modules, etc. This deposition reduces the generation potential of these photovoltaic modules significantly. On a longer period of time, the degradation of the panels set in which is also taken care in the quantifications of the various categories of loss that is accounted between the expected generation and the actual metered generation that is fed into the grid or consumed outside of the renewable park. Among the various categories of losses that are accounted for, key losses are that of the shadow loss, curtailment loss and the cloud loss.

Loss in electrical generation due to soiling in solar power plants is currently mitigated through periodic cleaning of photovoltaic modules. At regular intervals, the operators of a solar power plant clean the photovoltaic modules in the plant by washing them with water. This activity has been off late passed on to robotic arms for cost effective operations as well as work on extreme climatic conditions for large renewable parks with capacities more than 1 GW. The cleaning activity eliminates the dust and dirt accumulated on top of the modules and restores the generation potential of the plant to its optimal capacity. This process employs either a massive labor force or an automated task force in the form of robots along with considerable amounts of water. The process mandates cleaning of all photovoltaic modules in a park irrespective of whether it is impacted by soiling resulting in excessive use of resources and labor. To optimize the cleaning of photovoltaic modules, it is recommended to identify which panels are needed to clean and quantify the loss in generation due to soiling in photovoltaic modules and the quantum of energy that is retraceable after the cleaning exercise.

U.S. Pat. No. 9,126,341B1 enumerates a method to optimize the actual cleaning process of a solar power plant by enumerating and estimating the robotic components that would be required for a cleaning operation. However, this method only looks at the actual maintenance procedure and does not consider or determine which photovoltaic modules need cleaning in a solar power plant.

U.S. Pat. No. 9,590,559B2 by Jarnason et.al. suggests computing the expected generation patterns through the modelling of weather patterns on an ideal day and then determining the deviation of the expected energy from the actual electrical generation on the same day. However, this method assumes that the weather patterns can be easily predicted and modelled which may not be the case especially with respect to cloud patterns. The method does not consider the effective degradation of the photovoltaic modules that occurs over course of time.

Chinese Patent, CN102566435B enumerates a method to model the weather pattern for a day through the solar irradiance data to find the ideal weather pattern and employs a polynomial regression algorithm to find the expected energy that would be generated from photovoltaic modules. This method too assumes the ideality and predictability of weather patterns and does not consider the case of unreliable cloud patterns.

### SUMMARY OF THE INVENTION

An embodiment of a method to quantify and estimate the various losses in electrical generation in a solar power plant and hence to estimate and plan an optimal cleaning schedule is provided.

In the embodiment, it is assumed that photovoltaic modules in a solar power plant are connected in a series to maximize the current generated from these modules. Many such photovoltaic strings are connected in a parallel fashion to a device called a combiner box. Many such combiner boxes are again connected in a parallel manner to an inverter. Data is obtained from electrical meters connected at the output of these strings which is then read and aggregated using established industrial protocols like SCADA systems. The ingested data is then archived in a centralized data warehouse in the corporate infrastructure of the owner of the solar power plant or in the cloud. This data is then further intended to be used for identification of quantification of the solar losses.

In the embodiment, standardized data plumbing and data engineering techniques are used to clean the data archived in the centralized data warehouse. The archived data is also filtered to consider durations of significant generation potential when the irradiation is more than a significant threshold.

The embodiment initially tries to estimate the best performing string connected to an inverter or the string with the maximum current generated for a given amount of solar irradiance. The string forms the reference string based on which the remaining strings are compared to estimate the various losses.

The embodiment then computes the following losses—array mismatch loss, temperature induced degradation, unavailability loss at the combiner box as well as string level if sensors are present, tracker loss if configured, shadow loss, cloud loss, soiling and panel degradation losses for each inverter that is connected in the solar power plant. These losses are also archived in the centralized data warehouse.

The embodiment then feeds the following inputs—water resources available, labor resources available and the losses computed to a constraint-based optimization algorithm to determine the cleaning schedule of the different photovoltaic modules in the solar power plant and the resources that would be used for a cleaning activity.

Another embodiment of the disclosed method includes programming one or more monitoring devices to cause one or more processors to: (a) acquire data from a plurality of electrical meters connected to strings and combiner boxes in the solar plant, wherein the data pertains to a current generation pattern; (b) remove invalid data; (c) filter and aggregate the data into time intervals; (d) store the data in a centralized data warehouse; (e) determine an ideal combiner box current generation pattern based on the data; (f) quantify generation losses as a minimum difference between the ideal combiner box current generation pattern to a current generation pattern of a specified combiner box when running at peak performance; (g) adjust the current generation pattern by subtracting the generation losses; (h) identify a progressive increase in deviation of the adjusted current generation pattern with respect to the ideal combiner box current generation pattern; (i) compare the progressive increase in deviation to a deviation after a previous cleaning cycle; and (j) determine soiling loss as a net common deviation after the previous cleaning activity and the progressive increase in deviation.

### BRIEF DESCRIPTION OF THE DRAWINGS

FIGS. 1A and 1B illustrate high-level block diagrams of components and engines that comprise an embodiment of a system which quantifies the electrical generation losses in photovoltaic modules and optimizes the cleaning schedules for the solar power plants.

FIG. 2 is a flow chart illustrating an embodiment of the methodology of data ingestion and data cleansing before it is archived to the data warehouse.

FIG. 3 is a flow chart illustrating an embodiment of the method for identifying the electrical generation losses that occur in a solar power plant.

FIG. 4 is a flow chart illustrating an embodiment of the method for estimating and planning the cleaning activities in a solar power plant.

FIG. 5 schematically depicts a reduction in electrical generation caused by solar losses.

FIGS. 6A and 6B illustrate embodiments of sample electrical current trends varying in strings connected to a junction box.

FIG. 7 is a heatmap representation in the platform, which is used to identify the various electrical loss scenarios on a typical day of power generation.

### DEFINITIONS

RETINA is a patented software that is implemented enables proactive decision synchronization in real time to minimize the operational risk and maximize the process productivity for process industries.

A decision synchronization is used through the foregoing disclosure to refer to a timely and most appropriate recommendation or call-to-action or suggestions from this invention that would be applicable to various business users and areas such that the decisions that are identified by the invention reaches the appropriate stakeholders for completion and execution.

Supervisory Control and Data Acquisition (SCADA) is a control system architecture comprising computers, networked data communications and graphical user interfaces for high-level process management.

Photovoltaic modules (PV) modules are sheets made of materials like polycrystalline Silicon, monocrystalline Silicon and other materials that can generate electrical current when exposed to direct sunlight.

Electrical junction boxes (JB) or combiner boxes refer to a device capable of connecting to multiple strings of PV modules in parallel fashion to aggregate the electrical current generated from each of these strings and transmit to an electrical inverter.

Direct current (DC) is the form of current that is generated by PV module and refers to the unidirectional flow of electrical charge.

Alternating current (AC) is the form of current that is generated by inverters in a solar power plant and refers to alternating flow of electrical charges. It is to be understood that alternating current is the default mode in which electricity is transmitted across electrical grids.

Standard Testing conditions or STC refers to the ambient weather conditions under which a photovoltaic module was initially tested before getting commissioned. Usually this would refer to an ambient temperature of 25 degrees Centigrade and a solar irradiance of 1000 Watt per squared meter.

Nominal Operating Cell Temperature (NOCT) refers to the temperature of the module at which it can convert solar irradiance into electricity with the highest efficiency.

### DETAILED DESCRIPTION OF THE INVENTION

Solar power plants are constructed on the principle that there are materials that can convert the luminous irradiance from the sun directly into electrical power. These materials are assembled in the form of planar sheets called photovoltaic (PV) modules. Arrays of such modules are assembled in a solar power plant in a serial manner. Each array is termed as a string which aggregates the current generated from each photovoltaic module. Several such strings are connected in parallel to an electrical junction box. Several such junction boxes in turn, are connected to an inverter. The inverter is responsible for converting the direct current generated from the PV modules into alternating current which would then be injected into the electrical grid through an electrical substation.

It is observed that photovoltaic modules do not convert the entire sunlight that falls on it into electricity. Many photovoltaic modules operate with an optimal efficiency of 15-18%. Hence a significant quantity of potential energy is lost which can be categorized as, but not limited to:
Loss due to inherent resistance mismatch between different strings of photovoltaic modules termed as Array Loss;
Loss due to heat generation of panels at higher temperatures over design and STC conditions as Temperature Induced degradation;
Losses due to non-availability of photovoltaic modules for generation as unavailability losses;
Losses due to dips in solar irradiance caused by cloud movement across the plant are termed cloud losses;
Losses due to non-availability of panels due to restriction in offtake of the partial or entire power generated for a specific period of time imposed by the regulator or by any disturbances in the grid operations;
Losses dues due to shadows from nearby structures termed as shadow losses;
Losses due to accumulation of dirt and dust on top of photovoltaic modules called soiling losses; and
Losses due to reduction in the photovoltaic capability of modules over time termed as panel degradation losses.

Amongst the losses explained, the only losses which can be mitigated by owners and operating personnel of solar power plants are soiling loss and unavailability losses. The method described in the invention aims to first identify and quantify these losses to derive an optimized maintenance and cleaning schedule of photovoltaic modules.

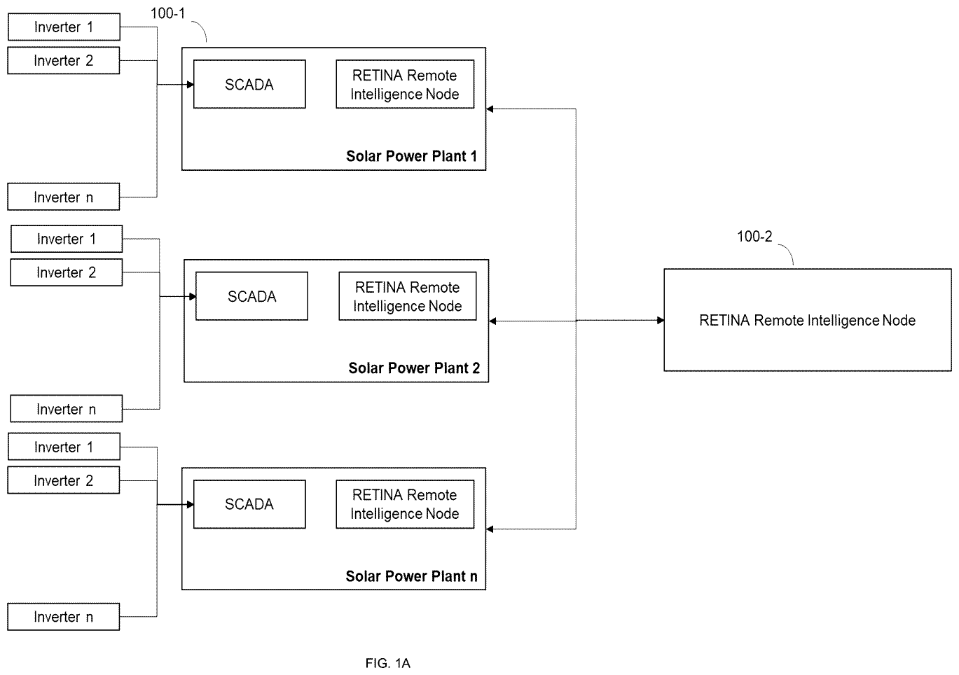

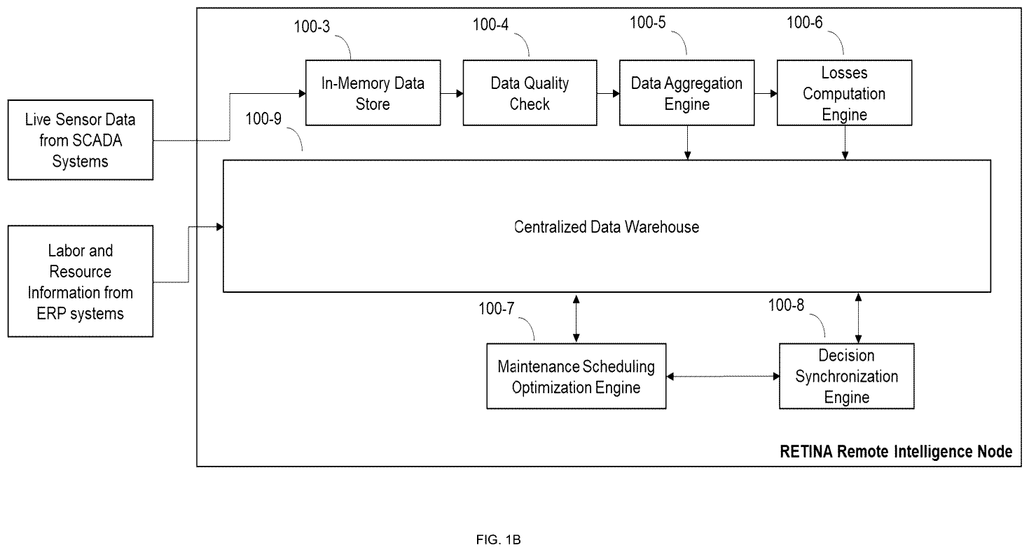

Combiner boxes and inverters in a solar power plant are connected to electrical meters which measure the electrical voltage, current and power that flows through these devices. Data is acquired from these meters and archived briefly into industrial SCADA systems. FIG. 1A shows a sample layout of how data is acquired from these meters and how the data in turn is read through RETINA's remote node. RETINA remote nodes may comprise one or more monitoring devices that are structured to read the data from the SCADA systems, and other possible fields sensors like weather monitoring stations that are deployed in a solar power plant, at time intervals of 1-30s. The incoming streaming data is then cleansed, filtered, and archived using the following steps:
a) Each data point from the SCADA system is checked to see whether the incoming values are acceptable, good, or bad based on the permissible range of values for each of the parameters configured within the SCADA system. Bad values are automatically rejected from the RETINA system to prevent unnecessary data transmission; and
b) Each parameter in the incoming streaming data is configured in the RETINA remote node to have permissible minimum and maximum level. If the incoming data exceeds these levels, the data is clipped to the specified boundary conditions.

As is shown in FIG. 1B, once the data streams into the RETINA central data warehouse node, the data is first pushed to an in-memory data store (100-3) which determines key performance indicators (KPI) like efficiency and asset status in real time. It has been observed that in live industrial asset-based systems, data variability is not high and can be considered to change in every 15 minutes. Thus, rather than storing the data that is streaming in from the RETINA remote node once every 30 seconds, the following data processing steps are applied to optimize the data that is required to be archived into RETINA's data warehouse. Still referring to FIG. 1B, the incoming data is first archived into a temporary non-RETINA data store through RETINA's data import and integration module. From there, the data is first checked for repetitiveness and quality through the data quality check module (100-4). Invalid and bad quality records are filtered and removed from the store.

The remainder of the dataset is then aggregated into 5-minute intervals (100-5) for which several data statistics are determined. In an embodiment, the following statistics of the parameters may be determined:
Average value of all parameters within the interval;
Max value of all parameters within the interval; and
Minimum value of all parameters within the interval.

The resulting data set from the above step is then pushed into RETINA's Consolidated Unified Data Archival Block (100-9) where it is then available to be processed/used by the decision synchronizer to predict the component temperature deviations.

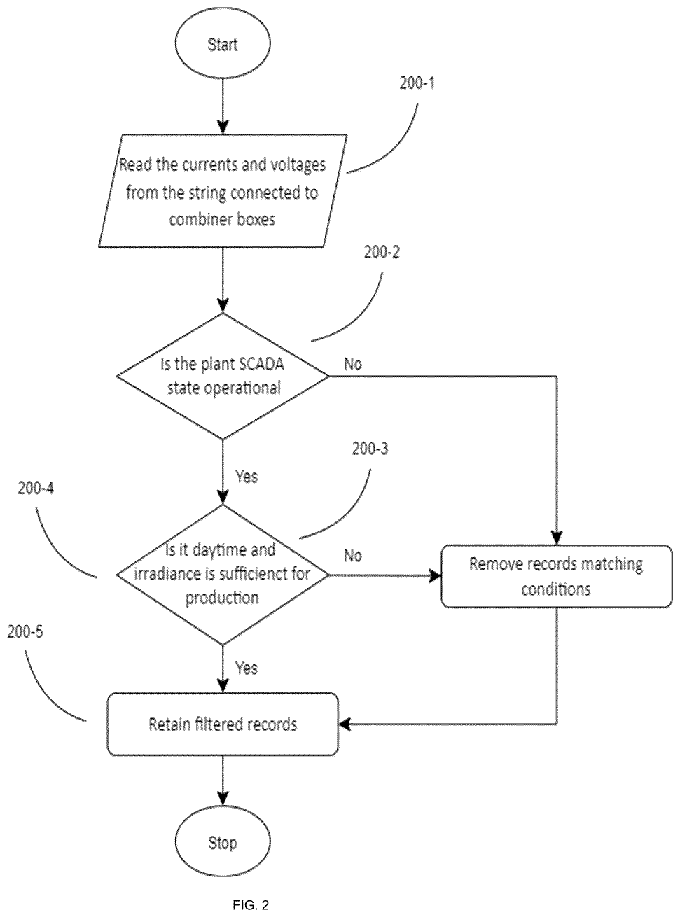

To determine/quantify the losses, the first step would be to cleanse or filter the records in the data warehouse, as represented in FIG. 2, when no or minimal irradiation is present like nighttime since no generation would occur during such conditions.

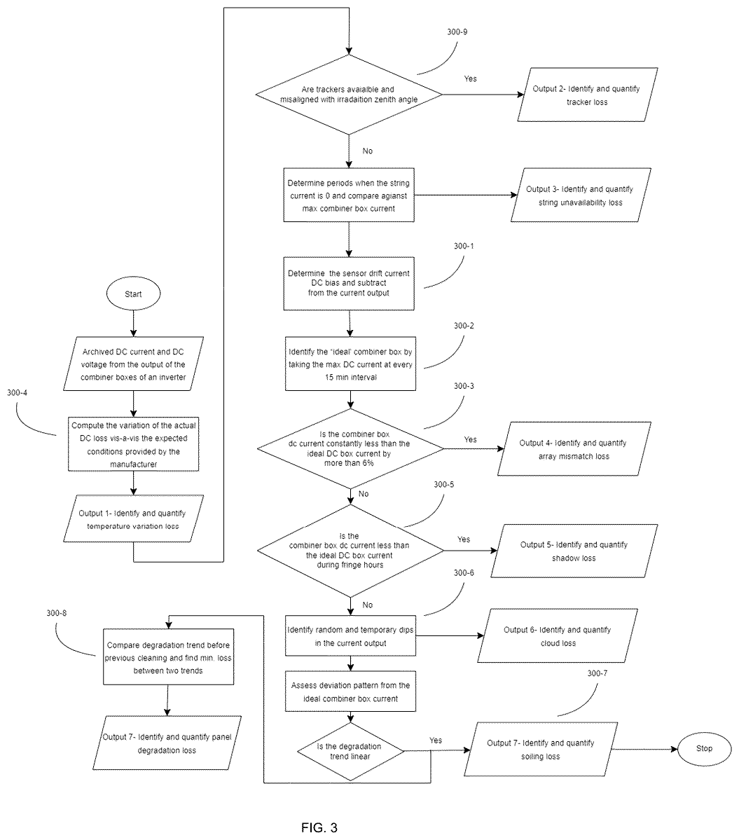

It has been observed that the current sensors connected to the strings attached to the combiner boxes might have differences between them either due to line losses, sensor drift or calibration issues. This may result in an erroneous reading of the string currents which in turn may result in an erroneous computation of losses in power generation. As shown in FIG. 3, the sensor drift is quantified as the minimal non-zero current observed in strings and combiner boxes when there is no irradiation present (300-1).

As mentioned, PV modules exhibit a linearly increasing trend of electricity generation with solar irradiance up to a certain temperature called Nominal Operating Cell temperature, beyond which the efficiency of the modules decrease causing a reduction in the electrical power generated from the modules. This loss is quantified and archived as the product of the drop in efficiency of the panel modules corresponding to the module temperature and the surface area of all the modules that are connected to a combiner box in a power plant (300-4).

Some solar power plants have a device called trackers attached to photovoltaic modules. These trackers are designed to orient the photovoltaic module in the direction of sunlight over the course of day to maximize the incident radiation on the modules and consequently the generation. However, sometimes errors in calibration or fault in the tracker motor may cause the modules to not be aligned correctly causing a dip from the expected production. This difference is quantified and archived as tracker losses.

The next step in FIG. 3 would be to identify the “ideal” combiner box current or the maximum current that can be realized by the strings connected to a combiner box for a given module temperature and irradiation (300-2). This current trend is then used as the reference trend to determine the remainder of the losses that are possible in a solar power plant.

It is assumed that combiner boxes connected to photovoltaic modules laid out close to each other will exhibit similar current generation patterns. Hence from a set of combiner boxes that are connected to a single inverter, the combiner box current variations at every periodic interval across a day are determined and is synchronized with the layout configuration of the solar power plant to determine the array loss (300-3). The array loss (300-3) is computed as the minimum difference between the current observed amongst in the “ideal” combiner box to the current in a specified combiner box when it is running at its highest performance.

As per the configuration of the solar power plant, each combiner box in turn comprises multiple strings that include a series of panels in parallel/series connection to generate max current from the solar irradiation. It is observed that the junction boxes may exhibit differential behavior due to cabling faults at the string/Junction box level itself. Hence the combiner boxes that consistently exhibit a scaled down generation pattern when compared to “ideal” combiner box are identified using a linear regression model against the irradiation. The same can be validated with the generation pattern, once the maintenance activity restores the power generation that is in line with the generation from other similar assets. The deviation or the difference in generation is determined and archived as string unavailability loss.

Usually, the combiner boxes produce current in relevance to the irradiation for most parts of the day. However, it could be observed that for a certain duration of time i.e., either in the morning hours (between 08:00-11:00) and/or after noon (between 14:30-17:30), the current generation shows a dropped pattern. This may be attributed to a shadow from a nearby obstruction or shadows from nearby panels, etc. The deviation between the power produced from strings impacted by the shadow to the “ideal” combiner box current is also seen to be consistent for the mentioned fringe duration throughout the operational duration. The deviation is quantified as shadow loss (300-4) for relevant number of strings connected to the combiner box.

Sometimes, photovoltaic modules connected to a combiner box may experience a sudden dip in the electrical power generation due to transient clouds moving across the plant. These are temporary, random, and could last for smaller or extended duration depending on the cloud pattern. The difficulty in correlating this drop to simultaneous drop in irradiation is since the heat generated in the panels due to irradiation prior to the occurrence of clouds may produce cross reference and could lead to false insights. Such periods are then derived as periods with cloud cover and the deviation in the current generation pattern is then estimated as cloud losses. To identify the cloud losses, the first order difference of the current generation trend is taken to identify the local minima (i.e., the troughs or dips due to cloud cover). A linear interpolation of the string current is also taken for this period to identify the ideal DC current pattern. The deviation between these two trends is then computed as cloud loss (300-5).

Once all the other losses are determined, the overall deviation in the generation trend of the current in a string connected to a combiner box from the “ideal” combiner box current is determined and is re-adjusted by subtracting all the other losses that have been computed above. The remainder trend is then inspected using a difference estimator to determine if there is a progressive increase in the deviation over the course of time. This increasing trend can occur due to soiling as well as due to panel degradation. To accurately segregate the two, the loss trend after the previous cleaning activity is considered and compared against the current deviation trend. It is expected that after every cleaning activity, the soiling effect is reset and hence the net common deviation after the previous cleaning activity and the current trend is quantified as panel degradation loss (300-8) and the remainder deviation is computed as soiling loss (300-7).

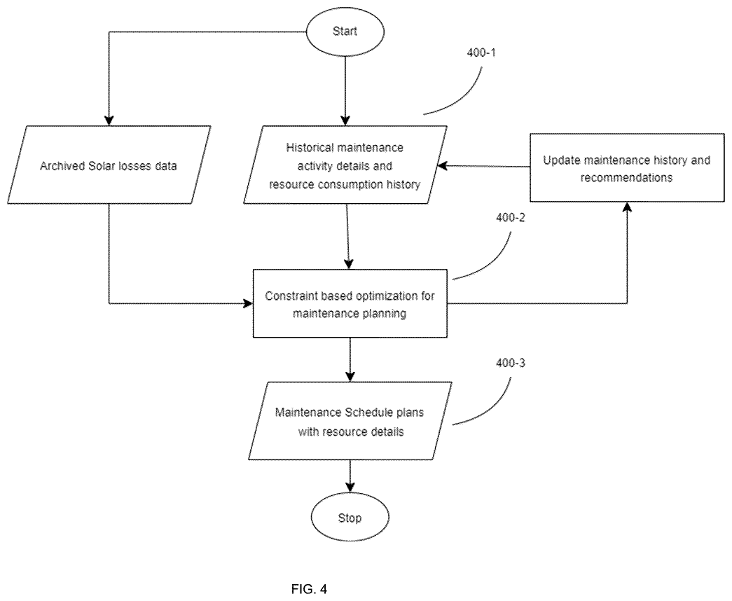

Once all the losses are quantified and archived, FIG. 4 explains the logic with which a cleaning schedule is proposed. This technique assumes the following inputs—The impact of panel performance in generation due to soiling, the labor cost involved and the amount of RO water that would need to be used for cleaning the panels and the site where the cleaning activity will be performed. The algorithm will then decide the ideal time for panel cleaning along with suggestions with the labor cost and the amount of water that would be required for cleaning the panels. This methodology replaces the regular periodic cleaning cycle of the panels that exists in practice whenever the performance ratio of a solar wind farm drops below a threshold and provides an optimized way of the maintenance activity that serves the purpose of sustainability along with optimized use of labor and resources. A potential for around 10-15% is envisaged in the O&M cost associated with these maintenance activities. In addition, the improvement in generation that is attributed to the quick identification of the faults associated in the operations is expected to be @0.5%.

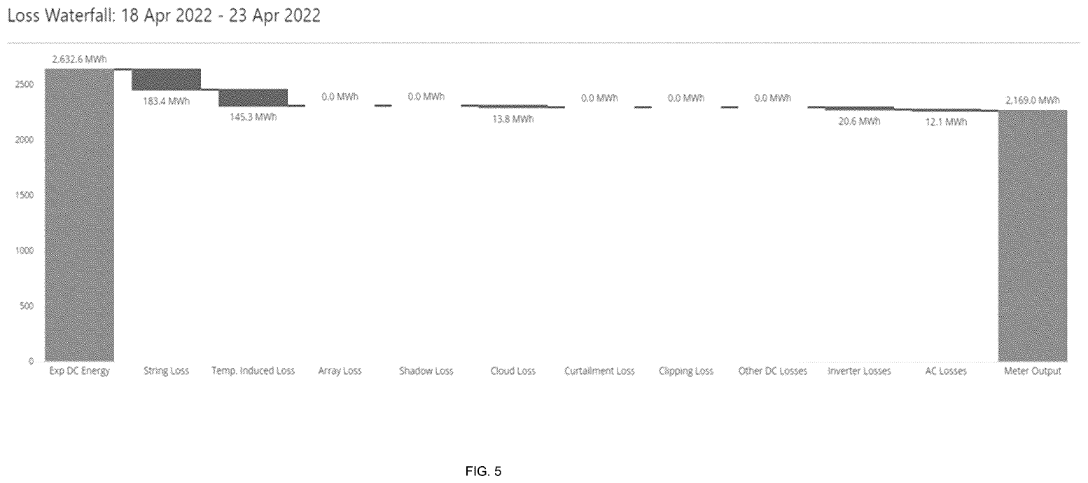

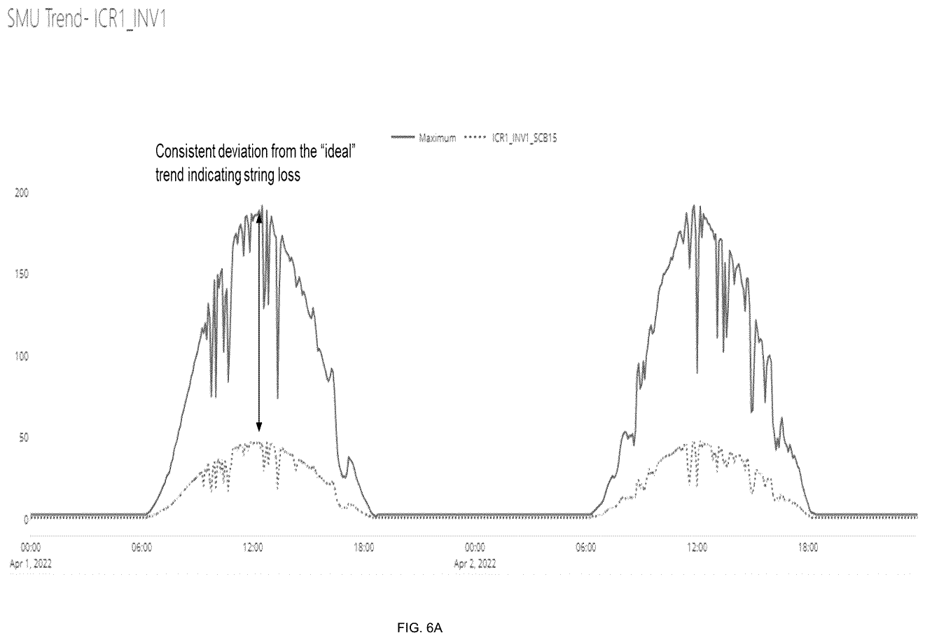

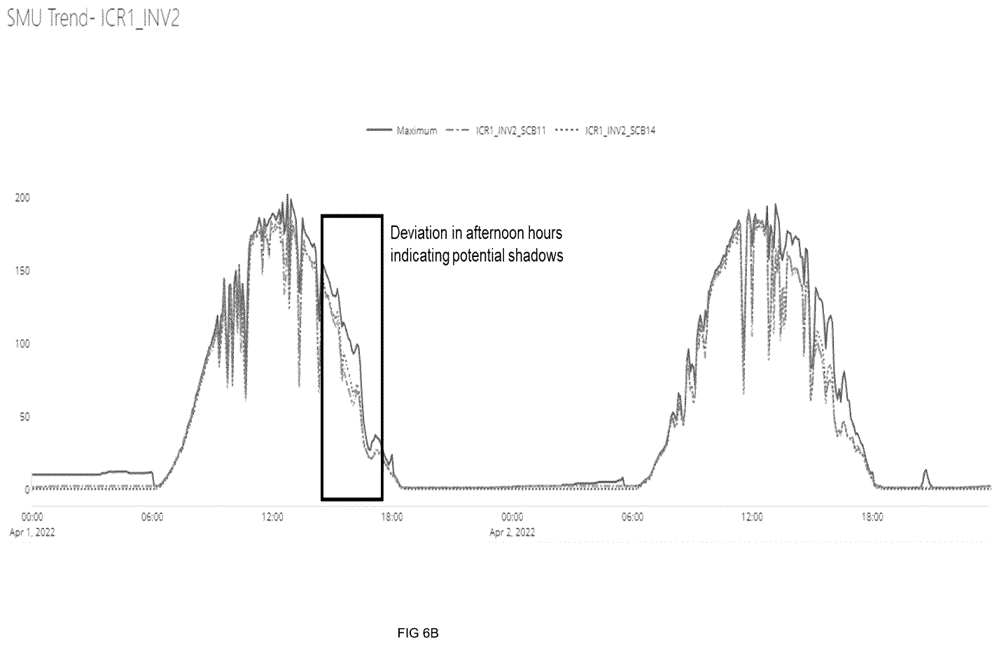

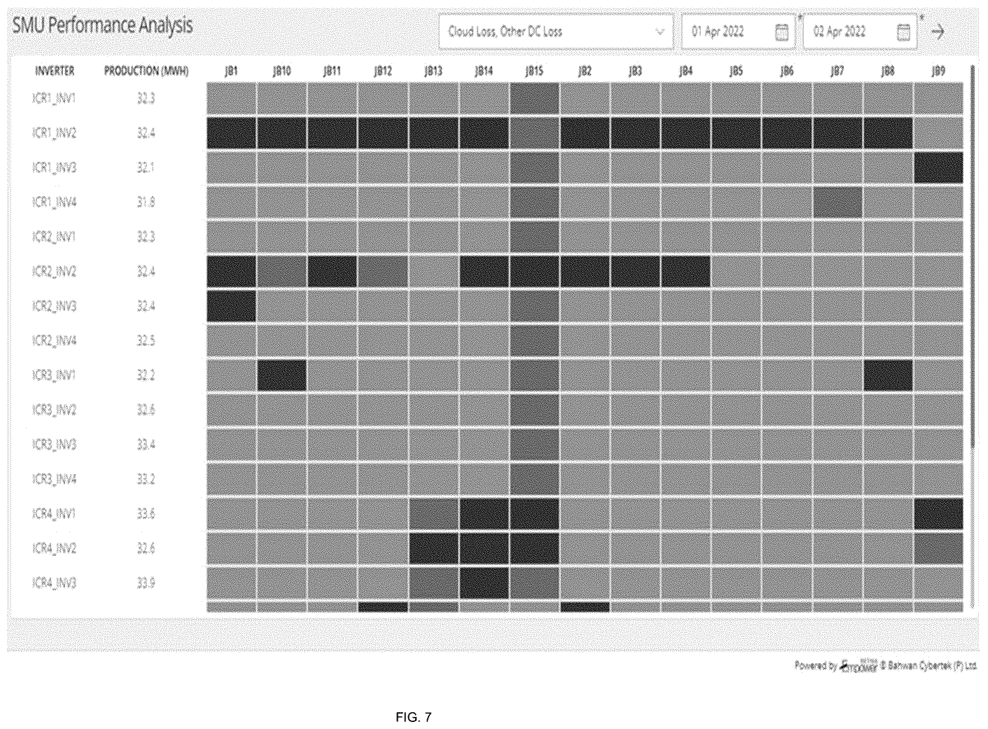

FIG. 5 shows the graphical representation of how the losses impact the generation of the power plant in the form of a waterfall chart. FIGS. 6A and 6B show the trend in the current generated from strings which experience string losses and shadow losses, respectively. FIG. 7 shows the systemic representation of the quantified losses as a heatmap correlating and identifying which combiner box of a solar power plant is experiencing a certain type of loss.

While the present invention has been particularly shown and described with reference to certain exemplary embodiments, it will be understood by one skilled in the art that various changes in detail may be affected therein without departing from the spirit and scope of the invention that can be supported by the written description and drawings. Further, where exemplary embodiments are described with reference to a certain number of elements, it will be understood that the exemplary embodiments can be practiced utilizing either less than or more than a certain number of elements.

1. A method for identifying and quantifying generation losses in a solar power plant due to soiling of photovoltaic modules, the method comprising:
programming one or more monitoring devices to cause one or more processors to:
acquire data from a plurality of electrical meters connected to strings and combiner boxes in the solar plant, wherein the data pertains to a current generation pattern,
remove invalid data,
filter and aggregate the data into time intervals,
store the data in a centralized data warehouse,
determine an ideal combiner box current generation pattern based on the data, and
quantify generation losses as a minimum difference between the ideal combiner box current generation pattern to a current generation pattern of a specified combiner box when running at peak performance,
adjust the current generation pattern by subtracting the generation losses,
identify a progressive increase in deviation of the adjusted current generation pattern with respect to the ideal combiner box current generation pattern,
compare the progressive increase in deviation to a deviation after a previous cleaning cycle, and
determine soiling loss as a net common deviation after the previous cleaning activity and the progressive increase in deviation.

2. The method of claim 1, wherein the generation loss comprises combiner box unavailability, wherein the combiner box unavailability is identified as combiner boxes consistently exhibiting a scaled down generation pattern when compared to the ideal combiner box current generation pattern.

3. The method of claim 2, wherein the generation loss comprises cloud loss, and wherein the cloud loss is identified by:
determining a first order difference of the ideal combiner box current generation pattern for a given period to identify the local minima corresponding to cloud cover; and
determining a linear interpolation of a string current for the period to identify an ideal DC current pattern,
determine a deviation between the first order difference of the ideal combiner box current generation pattern and the ideal DC current pattern, wherein the deviation corresponds to the cloud loss.

4. A method for creating a cleaning schedule for a solar power plant, comprising:
performing the method of claim 1 for each of a plurality of photovoltaic modules;
determining which of the plurality of photovoltaic modules need to be cleaned; and
determining when each of the plurality of photovoltaic modules need to be cleaned based on a quantity of resources to be used during the cleaning.

5. The method of claim 4, wherein the resources comprise at least one of water resources and labor resources.

6. The method of claim 1 Further comprising determining one or more data statistics, wherein the one or more data statistics include at least one of: (i) an average value within each time interval; (ii) a maximum value within each time interval; and (iii) a minimum value within each time interval.

7. The method of claim 1, wherein the data is aggregated into five minute intervals.

8. The method of claim 1, where the invalid data corresponds to times of day when minimal or no solar irradiation is present.

9. The method of claim 1, further comprising correcting data from the plurality of electrical meters to account for at least one of: (i) line losses; (ii); and (iii) sensor drift.

10. A method to identify and quantify the generation losses in a solar power plant, the method comprising:
a. acquiring data from electrical meters connected to strings and combiner boxes in the plant;
b. feeding the data into RETINA remote nodes;
c. filtering and aggregating the data into time intervals;
d. archiving the data in a centralized data warehouse; and
e. identify an ideal combiner box generation trend and determine the different losses possible in a solar power plant by estimating the deviation from the ideal trend under two or more different criteria.
